(19) United States
(12) Patent Application Publication
(10) Pub. No.: US 2004/0208643 A1
(43) Pub. Date: Oct. 21, 2004

(54) Coherent optical receivers

(75) Inventors: Kim B. Roberts, Nepean (CA); Maurice S. O'Sullivan, Ottawa (CA)

Correspondence Address: SMART & BIGGAR/FETHERSTONHAUGH & CO., P.O. BOX 2999, STATION D, 55 METCALFE STREET, OTTAWA, ON, K1P5Y6, CA

(73) Assignee: AR card

(21) Appl. No.: 10/142,870

(22) Filed: May 13, 2002

(51) Int. Cl. H04B 10/06

(52) U.S. Cl. 398/186

(57) ABSTRACT

In a coherent optical receiver, an incoming optical signal is combined with a local oscillator (LO) optical signal and the combined optical signals are detected by an optical detector and receiver arrangement. The receiver produces first and second loop control signals having respectively relatively slow and fast response speeds dependent upon frequency and phase variations between the incoming signal and the LO signal. An electrical source produces an electrical signal having a GHz frequency controlled by the second control signal. An optical source produces an optical signal with a first component having a first frequency controlled by the first control signal, and a second component having a frequency offset from the first frequency by a second frequency dependent upon the frequency of the electrical signal. The LO signal is derived from the second optical component via an optical filter and amplifier. The optical source can comprise a laser and an optical amplitude or phase modulator, or a dual- or multiple-frequency laser.

This invention relates to coherent optical receivers.

### BACKGROUND

In optical communications systems, it is known that coherent reception and detection of an optical signal can provide significant advantages, including, for example, improved receiver sensitivity and detection of modulation formats, such as FSK (frequency-shift keying) or PSK (phase-shift keying), other than intensity modulation. Chirp associated with intensity modulation of a semiconductor laser, which limits distances for transmission of an optical signal via a fiber, can be avoided by such other modulation formats.

In a homodyne coherent optical receiver, an incoming optical signal being received is optically combined with a local oscillator (LO) optical signal which is produced by a laser with its frequency and phase matched, using a phase locked loop (PLL), to the frequency and phase of the incoming signal. The LO optical signal is produced with a constant amplitude or electric field E₂ which is significantly larger than an amplitude or electric field E₁ of the incoming optical signal. The combined optical signal has an intensity proportional to (E₁+E₂)²=E₁²+E₂²+2E₁E₂ which is detected by a conventional optical detector. The term E₁² is a noise component which is small compared with the term E₂², which is a dc component and can be removed by filtering or by differential detection. The term 2E₁E₂ is proportional to the electric field E₁ of the incoming optical signal, so that the optical receiver provides an output dependent on this field E₁ (as distinct from the intensity E₁²).

Similar principles can be applied to a heterodyne optical receiver (in which the LO frequency is different from the frequency of the incoming signal). However, a heterodyne optical receiver requires an electrical bandwidth in the receiver that is substantially greater than the bit rate of data carried by the received optical signal, which increases noise and is expensive to implement at high bit rates. Accordingly, only homodyne optical receivers are discussed further below.

In one known form of homodyne coherent optical receiver, the LO signal produced by the laser can be coupled via a phase modulator which is controlled by the PLL to provide the desired phase matching. A disadvantage of this is that the phase modulator is required to have a very large dynamic range.

In another known form of homodyne coherent optical receiver, the PLL is used to control an electrical bias current of the laser thereby to control the frequency and phase of the LO optical signal produced by the laser. A disadvantage of this is that the frequency and phase of the LO optical signal are very sensitive to changes in the controlled current, so that the arrangement is susceptible to adverse effects of noise. Another disadvantage of this arrangement is that the frequency tuning responses of lasers are generally due to both thermal and carrier density effects. While both of these are dependent upon the bias current, they have different phase responses, so that a complex sum of the two effects creates a total tuning response that has severe problems at frequencies of the order of 1 MHz which are necessary for compensating for high frequency phase noise of lasers.

Accordingly, there is a need to provide an improved method for producing and controlling a LO optical signal for a coherent optical receiver, especially a homodyne receiver, and to provide an improved coherent optical receiver.

### SUMMARY OF THE INVENTION

According to one aspect of this invention there is provided a method of producing a local oscillator (LO) optical signal for combination with an incoming optical signal to be received by a coherent optical receiver, comprising the steps of: producing an optical signal having a first optical component having a first frequency and a second optical component having a frequency offset from the first frequency by a second frequency; controlling the first frequency with a first control signal having a relatively slow response speed and dependent upon relative frequency changes between the LO optical signal and the incoming optical signal; producing an electrical signal at a frequency harmonically related to the second frequency; controlling the frequency of the electrical signal, thereby to control the second frequency, with a second control signal having a relatively fast response speed and dependent upon relative phase changes between the LO optical signal and the incoming optical signal; and deriving the LO optical signal from said second optical component.

The step of deriving the LO optical signal from said second optical component preferably comprises optically filtering the optical signal having the first and second optical components to select the second optical component, and may comprise optically amplifying the second optical component.

In one embodiment of the method, the step of producing the optical signal having the first and second optical components comprises producing a LO carrier optical signal at the first frequency in dependence upon the first control signal, and modulating the LO carrier optical signal in dependence upon the electrical signal to produce the optical signal having the first and second optical components. The modulating step can comprise amplitude or phase modulation.

In another embodiment of the method, the step of producing the optical signal having the first and second optical components comprises producing said optical signal using an optical source for producing at least two frequencies, one of said at least two frequencies being said first frequency and the other of said at least two frequencies being spaced from said one of said at least two frequencies by said second frequency. Conveniently in this case the frequency of the electrical signal can be a subharmonic of the second frequency.

Another aspect of the invention provides a coherent optical receiver comprising: an optical coupler for combining an incoming optical signal to be received with a local oscillator (LO) optical signal to produce at least one combined optical signal; an optical detector and receiver arrangement responsive to the combined optical signal to produce a coherent output signal and two loop control signals having relatively slow and fast response speeds and dependent upon frequency and phase variations between the incoming optical signal and the LO optical signal; an electrical signal source; an optical signal generator arranged to produce an optical signal comprising a first optical component at a first frequency controlled by the first control signal and a second optical component at a frequency which is offset from the first frequency by a second frequency, said second frequency being dependent upon a frequency of an electrical signal produced by the electrical signal source and being controlled by the second control signal; and means for deriving the LO optical signal from said second optical component of the optical signal produced by the optical signal generator.

Preferably the means for deriving the LO optical signal comprises an optical filter for selecting the second optical component from the optical signal produced by the optical signal generator.

In one form of the receiver the optical signal generator can comprise an optical source, for producing a LO carrier optical signal at the first frequency in dependence upon the first control signal, and an optical modulator for modulating the LO carrier optical signal in dependence upon the electrical signal to produce the optical signal having the first and second optical components. Conveniently the electrical signal is a sinusoidal signal at the second frequency, and the optical modulator comprises a Mach-Zehnder modulator providing amplitude or phase modulation of the LO carrier optical signal. For example, the second frequency may be in a range from about 10 GHz to about 100 GHz.

In another form of the receiver the optical signal generator comprises an optical source for producing at least two frequencies, one of said at least two frequencies being said first frequency and the other of said at least two frequencies being spaced from said one of said at least two frequencies by said second frequency.

The electrical signal source can produce the electrical signal with a frequency which is a subharmonic of the second frequency.

A further aspect of the invention provides a coherent optical receiver comprising: an optical signal combiner arranged to combine an incoming optical signal to be received with a local oscillator (LO) optical signal to produce at least one combined optical signal; an optical detector and receiver arrangement responsive to said at least one combined optical signal to produce a coherently received signal and two loop control signals having relatively slow and fast response speeds dependent upon frequency and phase variations between the incoming optical signal and the LO optical signal; an electrical source for producing an electrical signal having a frequency controlled by the control signal having the relatively fast response speed; and an optical source for producing an optical signal comprising a first optical signal component having a first frequency controlled by the control signal having the relatively slow response speed and a second optical signal component having a frequency offset from the first frequency by a second frequency harmonically related to the frequency of the electrical signal, wherein the LO optical signal is derived from the second optical signal component.

### BRIEF DESCRIPTION OF THE DRAWINGS

The invention will be further understood from the following description by way of example with reference to the accompanying drawings, in which:

FIG. 1 schematically illustrates a known form of a homodyne coherent optical receiver;

FIG. 2 schematically illustrates a homodyne coherent optical receiver in accordance with an embodiment of this invention;

FIG. 3 is a spectral diagram relating to the receiver of FIG. 2;

FIG. 4 schematically illustrates a homodyne coherent optical receiver in accordance with another embodiment of this invention; and

FIG. 5 is a spectral diagram relating to the receiver of FIG. 4.

### DETAILED DESCRIPTION

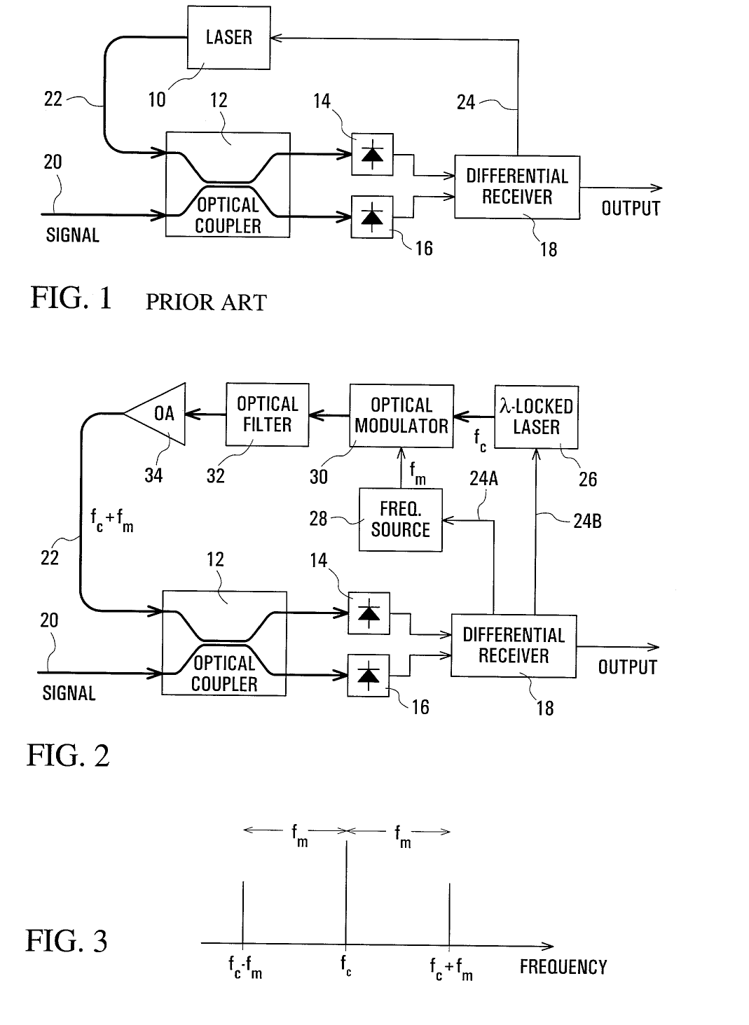

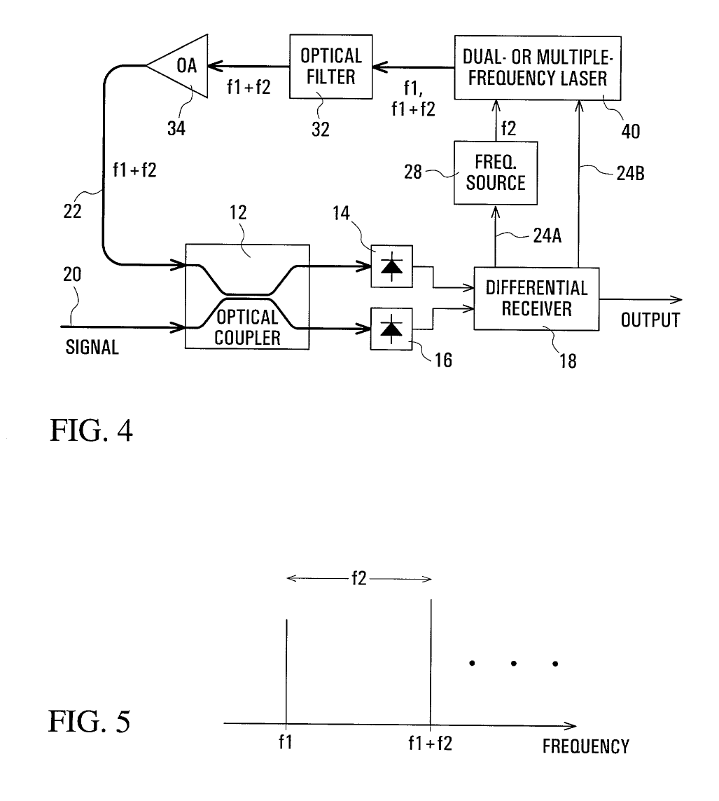

Referring to FIG. 1, a known homodyne coherent optical receiver comprises a laser 10, an optical coupler 12, two photo-diode detectors 14 and 16, and a differential receiver 18. In FIG. 1, and also in FIGS. 2 and 4 described below, optical paths are denoted by relatively thick lines to distinguish them from electrical paths. In the drawings, the same reference numerals are used in different figures to denote similar elements.

The optical coupler 12 is for example a 3 dB coupler having two inputs and two outputs. An incoming signal to be received and detected is supplied to one of the inputs of the coupler 12 via an optical fiber path 20, and a LO optical signal produced by the laser 10 is supplied to the other input of the coupler 12 via an optical path 22. The incoming and LO (local oscillator) optical signals are combined in the coupler 12 so that a combination of these signals is produced at each of the two outputs of the coupler. These outputs are optically coupled each to a respective one of the detectors 14 and 16 responsive to intensity of the combined optical signals supplied thereto.

Resulting electrical signals produced by the detectors 14 and 16 are supplied to differential inputs of the differential receiver 18, which produces an electrical output signal dependent upon the electrical field or amplitude (as distinct from intensity or square of the amplitude) of the incoming optical signal. An electrical feedback path 24 from the receiver 18 to the laser 10 serves to control the frequency and phase of the LO optical signal produced by the laser 10 in a PLL control arrangement to provide for coherent detection of the incoming optical signal.

Thus the PLL attempts to match the frequency and phase of the LO optical signal produced by the laser 10 to the frequency and phase of the incoming optical signal. However, due to factors including for example phase noise of the incoming optical signal and response speed of the PLL and laser 10, this matching is imperfect and the operation of the arrangement of FIG. 1 as a coherent optical receiver may not meet performance requirements. The receiver of FIG. 1 is also subject to the other disadvantages noted above.

FIG. 2 schematically illustrates a homodyne coherent optical receiver in accordance with an embodiment of this invention, in which the optical coupler 12, photo-diode detectors 14 and 16, differential receiver 18 and its output, and incoming signal on the optical path 20 are provided in the same manner as in the receiver of FIG. 1. In the receiver of FIG. 2, the electrical control path 24 and LO laser 10 of the receiver of FIG. 1 are replaced by two control paths 24A and 24B, a wavelength-locked (λ-locked) laser 26, an electrical frequency source 28, an optical modulator 30, an optical filter 32, and an optical amplifier (OA) 34. In this receiver an output of the optical amplifier 34 constitutes the LO optical signal which is supplied to the optical coupler 12 via the optical path 22. The optical filter 32 is preferably provided as illustrated but optionally may be omitted, and the optical amplifier 34 is also optionally present and may be omitted, as further described below.

In the optical receiver of FIG. 2, control signals on the paths 24A and 24B correspond to the control signal on the path 24 in the receiver of FIG. 1, but provide respectively relatively fast-response and slow-response control signals. For example, these control signals on the paths 24A and 24B can be derived by high-pass and low-pass filtering, respectively, a feedback output of the differential receiver 18 corresponding to the control path 24 in the optical receiver of FIG. 1.

The frequency source 28 serves to produce a sinusoidal electrical signal at a desired frequency fₘ which is variable within a relatively small range in dependence upon the control signal on the path 24A. For example, the desired frequency fₘ can conveniently be in a range from about 10 GHz to about 100 GHz, this range being determined as described further below. Typically and for example, the desired frequency fₘ may be of the order of 50 GHz. The sinusoidal electrical signal at this frequency fₘ is supplied as a modulating signal to the optical modulator 30.

The wavelength-locked laser 26 produces an optical signal at a LO carrier frequency f_{c}, which is stably controlled with a relatively slow response speed by the PLL control signal on the control path 24B. The laser 26 produces an optical output signal which is thereby wavelength-stabilized and is power-controlled to have a constant amplitude or intensity. For example, an optical signal from a back face of the laser may be filtered, differentially detected, and used in a locked loop to provide a frequency control signal for the laser, the control signal on the control path 24B being used to provide a setpoint for this loop to provide a relatively slow response over a relatively wide frequency range.

The optical output signal from the laser 26 is supplied to the optical modulator 30, in which it is modulated by the sinusoidal signal produced by the frequency source 28. The modulator 30 can, for example, be a MZ (Mach-Zehnder) modulator providing either phase or amplitude modulation of the laser 26 output signal. As shown by the spectral diagram in FIG. 3, an optical output of the modulator 30 consequently comprises a component at the LO carrier frequency f_{c} and upper and lower sideband components at frequencies f_{c}+fₘ and f_{c}−fₘ respectively, the sideband components having a lower intensity than the LO carrier frequency component. The upper and lower sideband components have the same phase as one another if the modulator 30 is an amplitude modulator, and have opposite phases if the modulator 30 is a phase modulator.

The optical filter 32 is supplied with the optical output of the modulator 30 and serves to pass to its output a selected one of the two sidebands, substantially suppressing the LO carrier frequency f_{c} and the other, non-selected, sideband. Although either sideband can be selected, it is assumed here for example that the upper sideband at the frequency f_{c}+fₘ is selected, and that the optical filter 32 suppresses the optical components at the frequencies fc and f_{c}−fₘ. This selected sideband at the frequency f_{c}+fₘ is amplified by the optical amplifier 34 to constitute a resulting LO signal on the optical path 22, thereby to be combined with the incoming optical signal in the optical coupler 12 as described above.

In the optical receiver of FIG. 2 the selected sideband is matched in frequency and phase to the frequency and phase of the incoming optical signal on the optical path 20. The PLL control via the path 24B provides a slow response over a wide frequency range, changing the LO carrier frequency f_{c}, and consequently also the sideband frequencies f_{c}+fₘ and f_{c}-fₘ, slowly so that the selected sideband frequency matches slow changes in the frequency of the incoming optical signal. The PLL control via the path 24A provides a fast response over a small frequency range, changing the frequency fₘ, by which the LO carrier frequency is offset to match the incoming signal frequency, rapidly to match fast changes in the incoming optical signal for example due to phase noise.

In other words, the optical receiver of FIG. 2 provides two control paths, one providing a slow but wide frequency response for a first frequency (the LO carrier frequency f_{c}), and the other providing a fast but narrow frequency response for a second frequency fₘ by which the first frequency is offset to match the incoming signal.

It can be appreciated that, in the optical receiver of FIG. 2, the optical filter 32 can potentially be omitted, all of the components of the optical output of the modulator 30 then being supplied to the optical coupler 12 and being combined with the incoming optical signal. While possible, this is not preferred because it results in additional optical signal combinations and may, depending upon the frequency fₘ, also impose an undue restriction on data bandwidth of the incoming optical signal.

It can also be appreciated that, whether or not the optical filter 32 is present, the optical amplifier 34 can potentially be omitted, especially if the selected sideband has a significant amplitude. For example, it is possible for the selected sideband to contain up to about 25% of the energy of the LO carrier frequency produced by the laser 26. However, it is desirable for the intensity of the LO signal on the optical path 22 to be significantly greater than that of the incoming optical signal, and so it may be preferable for the optical amplifier 34 to be included as illustrated in FIG. 2. Obviously, it is possible for the positions of the optical filter 32 and the optical amplifier 34 to be reversed, or for their functions to be combined.

It can be appreciated from the above description that the frequency fₘ provides a frequency offset which enables the optical filter 32 to separate the selected sideband from the LO carrier frequency and the non-selected sideband. The bandwidth of the optical filter 32 thus presents a lower limit, which for example may be of the order of 10 GHz as indicated above, for the frequency fₘ. In the absence of the optical filter 32, a lower limit for the frequency fₘ is presented by a need to avoid overlap of the bandwidth of the incoming optical signal on the path 20, modulated with data, with the LO carrier frequency f_{c}. An upper limit for the frequency fₘ, which for example may be of the order of 100 GHz as indicated above, is determined by a need for the selected sideband to have a sufficient amplitude, a response of the optical modulator 30 being such that the sidebands are produced with decreasing amplitude as the modulating frequency is increased.

In contrast to the optical receiver of FIG. 1, in which the PLL attempts to control the laser 10 both slowly over a relatively wide frequency band, and rapidly for relatively small and fast changes, of the incoming optical signal on the optical path 20, the optical receiver of FIG. 2 provides only a slow control of the frequency of the wavelength-locked laser 26, and fast changes, for example due to phase noise of the incoming optical signal, are matched by varying the frequency fₘ produced by the frequency source 28. As the frequency source 28 is controlled by an electrical control signal on the path 24A and produces an electrical (sinusoidal) signal for the optical modulator 30, it can provide a rapid response enabling the fast changes in the incoming optical signal to be precisely matched.

While the optical receiver of FIG. 2 provides a particularly convenient way of producing the LO signal on the optical path 22 using a stable frequency f_{c} and an offset frequency fₘ, the invention in its broadest aspects is not limited to this but embraces any manner of producing the LO signal on the optical path 22 from a first frequency which is stably controlled relatively slowly by a first control signal and a second, offsetting, frequency which can be rapidly controlled by a second control signal, the LO signal being dependent upon both the first frequency and the second frequency.

By way of example, FIG. 4 illustrates a homodyne coherent optical receiver in accordance with another embodiment of the invention, in which the wavelength-locked laser 26 and optical modulator 30 in the optical receiver of FIG. 2 are replaced by a dual- or multiple-frequency laser 40. The other components of the optical receiver of FIG. 4 are similar to, and are given the same references as, the corresponding components of the optical receiver of FIG. 2. FIG. 5 is a spectral diagram relating to the optical receiver of FIG. 4.

Referring to FIGS. 4 and 5, the dual- or multiple-frequency laser 40 operates to produce an optical signal with components having at least a first frequency f1 and a second frequency f1+f2; as shown by ellipsis in FIG. 5 it may also have components at other frequencies.

As in the optical receiver of FIG. 2, in the optical receiver of FIG. 4 the differential receiver 18 provides two control signals, one on the path 24B for providing a relatively wide-band slow frequency control and the other on the path 24A for providing a relatively narrow-band frequency or phase control. The control signal on the path 24A is supplied to the frequency source 28 to control a frequency f2 of an electrical signal generated by this source 28.

The control signal on the path 24B serves to determine in a stable manner the frequency f1 of one of the components of the optical signal produced by the laser 40, thereby also controlling the frequency f1+f2 of the other component shown in FIG. 5 (and any other components of the optical signal which may be present at other frequencies and which are not shown in FIG. 5). The control signal on the path 24A serves to determine the frequency f2 produced by the frequency source 28 and by which the frequency f1+f2 of this other component is offset from the component of the optical signal at the frequency f1. Accordingly, the component of the optical signal at the frequency f1+f2 is controlled for both stable frequency and rapid phase adjustment by the combination of the control signals on the paths 24A and 24B.

In the optical receiver of FIG. 4, the optical filter selects only the component of the optical signal from the laser 40 at the frequency f1+f2, and the optical amplifier 34 amplifies this component to constitute the LO optical signal with this frequency, which is determined to match the frequency of the incoming optical signal on the optical path 20. The optical filter 32 and/or the optical amplifier 34 can be omitted from the optical receiver of FIG. 4 with similar considerations to those described above in relation to the optical receiver of FIG. 2. The frequencies f1 and f2 are likewise selected with similar considerations to the bandwidth of the optical filter 32 and/or the bandwidth of data carried by the incoming optical signal on the optical path 20, and to the need for generating and controlling the optical signal components at the frequencies f1 and f1+f2 in the laser 40.

For example, the laser 40 can be a mode-locked laser which produces an optical signal having components at multiple frequencies spaced by the frequency f2 generated by the frequency source 28 and applied as a dither frequency to the laser, the laser having a cavity length controlled by the control signal on the path 24B and including an optical gate to lock the cavity modes in phase. In this case, the optical filter 32 can serve to select only one of the multiple optical signal components, having a desired frequency to match the frequency of the incoming optical signal on the optical path 20.

Alternatively, the laser 40 can be a dual frequency mode laser in which a difference between mode frequencies is controlled to keep the optical phase of one of the modes coincident with the incoming optical signal phase. One example of such a laser is known from “Frequency Multiplication of Microwave Signals by Sideband Optical Injection Locking Using a Monolithic Dual-Wavelength DFB Laser Device” by Charles Laperle et al., IEEE Transactions on Microwave Theory and Techniques, Vol. 47, No. 7, July 1999, pages 1219-1224. Another example of such a laser is known from “Tunable Millimeter-Wave Generation with Subharmonic Injection Locking in Two-Section Strongly Gain-Coupled DFB Lasers” by Jin Hong et al., IEEE Photonics Technology Letters, Vol. 12, No. 5, May 2000, pages 543-545.

The dual frequency mode laser is constructed so that both frequency modes share all or part of the same gain volume. In a locked mode of operation, the two frequency modes are locked to one another by an RF drive, applied to the laser drive, whose frequency is an integer divisor of the desired difference in laser mode frequencies. The relative stability of the frequency difference in locked mode is the same as the relative stability of the RF source used for locking.

Using a dual frequency mode laser 40 in the homodyne coherent optical receiver of FIG. 4, the frequency source 28 provides the RF drive at a frequency which is a subharmonic of the desired offset frequency f2 (i.e. the frequency f2 is an integer multiple, or harmonic, of the actual frequency produced by the frequency source 28). One of the frequency modes of the dual frequency mode laser 40 is locked to a secondary reference (such as an etalon) using a lower frequency bias control loop, and the other is locked to the phase of the incoming optical signal using the fast decision feedback loop which controls the frequency of the source 28 via the path 24A. An advantage of this arrangement is that the RF drive loop does not suffer the same laser response time characteristics as the bias loop, but rather is fast and able to track fast phase changes of the incoming optical signal carrier.

The invention is not limited to the particular ways described above for controlling the laser 24 and optical modulator 30 in the optical receiver of FIG. 2, or the laser 40 in the optical receiver of FIG. 4, to produce the LO optical signal with the desired frequency (e.g. f_{c}+fₘ in the receiver of FIG. 2, or f1+f2 in the receiver of FIG. 4), but extends to any manner of producing such a LO optical signal in dependence upon both a stably controlled first frequency (e.g. f1) and a second or offsetting frequency (e.g. f2) which can be rapidly controlled (e.g. at frequencies of the order of 1 MHz to compensate for high frequency phase noise of lasers). In each case the control can have any desired form. For example, although electrical control of the optical modulator 30 is described above using a MZ modulator, instead the generated frequency f2 can be used to provide an acoustic signal for acousto-optic modulation of an optical signal from a laser in a similar manner. In addition, it can be appreciated from the above description that the frequency source 28 can either produce the offsetting frequency (e.g. f2) itself, or it can produce another frequency, e.g. a subharmonic or harmonically related frequency, from which the offsetting frequency (e.g. f2) is produced within the laser 40.

In each of the embodiments of the invention described above, the two photo-diode detectors 14 and 16 are provided in conjunction with a differential receiver as is preferred. However, a single photo-diode detector can instead be used with a receiver having a single-ended input. In this case it can be appreciated that the detected intensity (amplitude-squared) of the LO optical signal supplied to the detector from the optical coupler 12 (the term E₂² discussed in the Background above) is a dc component which can be filtered and thereby removed from the output of the receiver.

Thus although particular embodiments of the invention are described above in detail, it can be appreciated that these and numerous other modifications, variations, and adaptations may be made without departing from the scope of the invention as defined in the claims.

1. A method of producing a local oscillator (LO) optical signal for combination with an incoming optical signal to be received by a coherent optical receiver, comprising the steps of:
producing an optical signal having a first optical component having a first frequency and a second optical component having a frequency offset from the first frequency by a second frequency;
controlling the first frequency with a first control signal having a relatively slow response speed and dependent upon relative frequency changes between the LO optical signal and the incoming optical signal;
producing an electrical signal at a frequency harmonically related to the second frequency;
controlling the frequency of the electrical signal, thereby to control the second frequency, with a second control signal having a relatively fast response speed and dependent upon relative phase changes between the LO optical signal and the incoming optical signal; and
deriving the LO optical signal from said second optical component.

2. A method as claimed in claim 1 wherein the step of deriving the LO optical signal from said second optical component comprises optically filtering the optical signal having the first and second optical components to select the second optical component.

3. A method as claimed in claim 2 wherein the step of deriving the LO optical signal from said second optical component comprises optically amplifying the second optical component.

4. A method as claimed in claim 1 wherein the step of producing the optical signal having the first and second optical components comprises producing a LO carrier optical signal at the first frequency in dependence upon the first control signal, and modulating the LO carrier optical signal in dependence upon the electrical signal to produce the optical signal having the first and second optical components.

5. A method as claimed in claim 4 wherein the step of modulating comprises amplitude modulation.

6. A method as claimed in claim 4 wherein the step of modulating comprises phase modulation.

7. A method as claimed in claim 4 wherein the step of deriving the LO optical signal from said second optical component comprises optically filtering the optical signal having the first and second optical components to select the second optical component.

8. A method as claimed in claim 7 wherein the step of deriving the LO optical signal from said second optical component comprises optically amplifying the second optical component.

9. A method as claimed in claim 1 wherein the step of producing the optical signal having the first and second optical components comprises producing said optical signal using an optical source for producing at least two frequencies, one of said at least two frequencies being said first frequency and the other of said at least two frequencies being spaced from said one of said at least two frequencies by said second frequency.

10. A method as claimed in claim 9 wherein the step of deriving the LO optical signal from said second optical component comprises optically filtering the optical signal having the first and second optical components to select the second optical component.

11. A method as claimed in claim 10 wherein the step of deriving the LO optical signal from said second optical component comprises optically amplifying the second optical component.

12. A method as claimed in claim 9 wherein the frequency of the electrical signal is a subharmonic of the second frequency.

13. A coherent optical receiver comprising:
an optical coupler for combining an incoming optical signal to be received with a local oscillator (LO) optical signal to produce at least one combined optical signal;
an optical detector and receiver arrangement responsive to the combined optical signal to produce a coherent output signal and two loop control signals having relatively slow and fast response speeds and dependent upon frequency and phase variations between the incoming optical signal and the LO optical signal;
an electrical signal source;
an optical signal generator arranged to produce an optical signal comprising a first optical component at a first frequency controlled by the first control signal and a second optical component at a frequency which is offset from the first frequency by a second frequency, said second frequency being dependent upon a frequency of an electrical signal produced by the electrical signal source and being controlled by the second control signal; and
means for deriving the LO optical signal from said second optical component of the optical signal produced by the optical signal generator.

14. A coherent optical receiver as claimed in claim 13 wherein the means for deriving the LO optical signal comprises an optical filter for selecting the second optical component from the optical signal produced by the optical signal generator.

15. A coherent optical receiver as claimed in claim 13 wherein the means for deriving the LO optical signal comprises an optical amplifier for amplifying the second optical component of the optical signal produced by the optical signal generator.

16. A coherent optical receiver as claimed in claim 13 wherein the optical signal generator comprises an optical source, for producing a LO carrier optical signal at the first frequency in dependence upon the first control signal, and an optical modulator for modulating the LO carrier optical signal in dependence upon the electrical signal to produce the optical signal having the first and second optical components.

17. A coherent optical receiver as claimed in claim 16 wherein the electrical signal is a sinusoidal signal at the second frequency, and the optical modulator comprises a Mach-Zehnder modulator providing amplitude or phase modulation of the LO carrier optical signal.

18. A coherent optical receiver as claimed in claim 13 wherein the optical signal generator comprises an optical source for producing at least two frequencies, one of said at least two frequencies being said first frequency and the other of said at least two frequencies being spaced from said one of said at least two frequencies by said second frequency.

19. A coherent optical receiver as claimed in claim 13 wherein the second frequency is in a range from about 10 GHz to about 100 GHz.

20. A coherent optical receiver as claimed in claim 13 wherein the electrical signal source produces the electrical signal with a frequency which is a subharmonic of the second frequency.

21. A coherent optical receiver as claimed in claim 13 wherein the optical detector and receiver arrangement comprises differential optical detectors and a differential receiver.

22. A coherent optical receiver comprising:
an optical signal combiner arranged to combine an incoming optical signal to be received with a local oscillator (LO) optical signal to produce at least one combined optical signal;
an optical detector and receiver arrangement responsive to said at least one combined optical signal to produce a coherently received signal and two loop control signals having relatively slow and fast response speeds dependent upon frequency and phase variations between the incoming optical signal and the LO optical signal;
an electrical source for producing an electrical signal having a frequency controlled by the control signal having the relatively fast response speed; and
an optical source for producing an optical signal comprising a first optical signal component having a first frequency controlled by the control signal having the relatively slow response speed and a second optical signal component having a frequency offset from the first frequency by a second frequency harmonically related to the frequency of the electrical signal, wherein the LO optical signal is derived from the second optical signal component.

23. A coherent optical receiver as claimed in claim 22 wherein the optical source comprises a source of the first optical signal component having the first frequency controlled by the control signal having the relatively slow response speed, and an optical modulator arranged to modulate the first optical signal component in dependence upon the electrical signal to produce the second optical signal component.

24. A coherent optical receiver as claimed in claim 23 and including an optical filter for selecting the second optical signal component from an optical output of the optical modulator to constitute the LO optical signal.

25. A coherent optical receiver as claimed in claim 22 and including an optical filter for selecting the second optical signal component from an optical output of the optical source to constitute the LO optical signal.

26. A coherent optical receiver as claimed in claim 22 wherein the optical source comprises a laser for producing the first and second optical signal components.

27. A coherent optical receiver as claimed in claim 26 wherein the electrical source produces the electrical signal with a frequency which is a subharmonic of the second frequency.
